(19) United States
(12) Patent Application Publication
(10) Pub. No.: US 2009/0222170 A1
(43) Pub. Date: Sep. 3, 2009

(54) Lane maintenance assistant for motor vehicles

(76) Inventors: Michael Scherl, Bietigheim (DE); Michael Weilkes, Diekholzen (DE); Lutz Buerkle, Leonberg (DE); Tobias Rentschler, Pforzheim (DE)

Correspondence Address: KENYON & KENYON LLP, ONE BROADWAY, NEW YORK, NY, 10004, US

(21) Appl. No.: 11/919,853

(22) PCT Filed: Apr. 26, 2006
(86) PCT No.: PCT/EP2006/061840

§ 371 Date: Jan. 23, 2009

(30) Foreign Application Priority Data
May 27, 2005 (DE) 10 2005 024 382.7

(51) Int. Cl. B62D 6/00; B60W 30/12

(52) U.S. Cl. 701/44

(57) ABSTRACT

Lane maintenance assistant for motor vehicles, having a sensor device for recognizing the lanes on the roadway, a control device that exerts a force on the steering system of the vehicle via an actuating element in order to hold the vehicle in the lane, and a device for recognizing an intention to change lanes on the part of the driver, wherein the control device is fashioned so as to asymmetrically modify the force exerted on the steering system when a lane change intention is recognized, in order to make the lane change easier.

### FIELD OF THE INVENTION

The present invention relates to a lane maintenance assistant for motor vehicles, having a sensor device for recognizing the lanes on the roadway, a control device that exerts forces on the vehicle steering system via an actuating element in order to keep the vehicle in the lane, and a device for recognizing an intention to change lanes on the part of the driver.

### BACKGROUND INFORMATION

A lane change assistant is discussed for example in DE 101 14 470. As a sensor device, a video system is provided with which the lane markings on the roadway, and thus the lateral position of the home vehicle relative to the lane in which the home vehicle is currently traveling—called the “home lane” hereinafter—can be recognized. If the lateral position of the vehicle deviates from the center of the lane by more than a specified tolerance limit to one side or the other, a regulating intervention in the steering system automatically takes place in order to guide the vehicle back to approximately the center of the lane. This significantly increases driving comfort, and also increases traffic safety because the driver can then concentrate fully on the traffic situation.

However, if the driver wishes to intentionally change lanes, for example in order to pass another vehicle, when the lane maintenance function is active he must exert greater force on the steering wheel in order to overcome the forces resulting from the regulating intervention of the lane maintenance assistant. For this reason, in the known system it is provided that if an intention to change lanes on the part of the driver is recognized, for example due to an actuation of the turn signal (blinker), the lane maintenance function is deactivated at least temporarily.

### SUMMARY OF THE INVENTION

The invention having the features described herein offers the advantage that comfort and safety during an intentional lane change are further improved.

According to the exemplary embodiments and/or exemplary methods of the present invention, when there is a recognized intention to change lanes, the lane maintenance assistant is not completely deactivated; rather, the force exerted on the steering system, or more precisely the degree to which this force is a function of the lateral position of the vehicle, is asymmetrically modified in such a way that the lane change in the direction towards the recognized target lane is made easier, while deviations from the center of the lane in the opposite direction continue to trigger a corrective regulating intervention. For this purpose, it is necessary to recognize not only the lane change intention as such, but also the direction of the lane change. However, this precondition is already met when the lane change is recognized, for example on the basis of the state of the turn signal indicator.

The particular advantage of the proposed solution is that it reduces the danger that the driver will stray from the home lane too far in the opposite direction when preparing to change lanes. If, for example, the driver intends to move into the passing lane (i.e., the left lane in countries where driving takes place on the right), if there is a high degree of traffic density the driver must pay attention primarily to traffic behind him in the target lane, for example by watching the rearview mirror or by turning around in order to observe vehicles in the “dead spot,” until the correct moment arrives for merging with the traffic in the adjacent lane. In this context, there is a danger of drifting too far to the right, in particular when driving on a curve to the left. This is effectively prevented by the exemplary embodiments and/or exemplary methods of the present invention.

Advantageous developments and constructions of the exemplary embodiments and/or exemplary methods of the present invention are described herein.

In an advantageous specific embodiment, the connection between the force exerted on the steering system by the lane maintenance assistant and the lateral position of the vehicle is modified in such a way that towards the end of the lane change process a corrective regulating intervention also takes place if the driver overshoots the target trajectory in the target lane, e.g. if he overshoots the center of the target lane. According to a development, it is also conceivable that the lane change assistant actively supports the actual lane change process, e.g. as soon as, on the basis of the driver's steering movements or by acknowledging a lane change recommendation outputted by the system, it is recognized that the driver actually wishes to initiate the lane change.

If the vehicle is equipped not only with a lane maintenance assistant but also with an adaptive cruise control (ACC) system, for example based on a proximity radar system, the recognition of the lane change intention can take place not only on the basis of the state of the turn signal indicator, but also, optionally or additionally, on the basis of the traffic situation recognized by the proximity radar system. For example, when approaching a slower-moving vehicle traveling in front of the home vehicle in the home lane, an intention to pass, and thus an impending change to the passing lane, can be assumed. Conversely, the intention to change lanes to the right can be assumed if the radar system recognizes that the adjacent lane to the right is open. However, the lane change should always be introduced by an interaction with the driver, e.g. through the actuation of a button, a voice command, or the like. Systems have also already been proposed in which traffic behind the home vehicle is monitored, for example with the aid of a radar system, and, depending on the traffic situation, the driver is given a recommendation for a lane change. In this case, when the lane change recommendation is outputted a lane change intention can also be assumed, and the lane maintenance function can be correspondingly adapted, e.g. in that the system enables the lane change (by reducing the force characteristic) only when the traffic behind the home vehicle permits this.

An exemplary embodiment of the present invention is shown in the drawings and is explained in more detail in the following description.

### BRIEF DESCRIPTION OF THE DRAWINGS

FIG. 1 shows a block diagram of the lane maintenance assistant according to the exemplary embodiments and/or exemplary methods of the present invention.

FIG. 2 shows a diagram for explaining the manner of functioning of the lane maintenance assistant.

### DETAILED DESCRIPTION

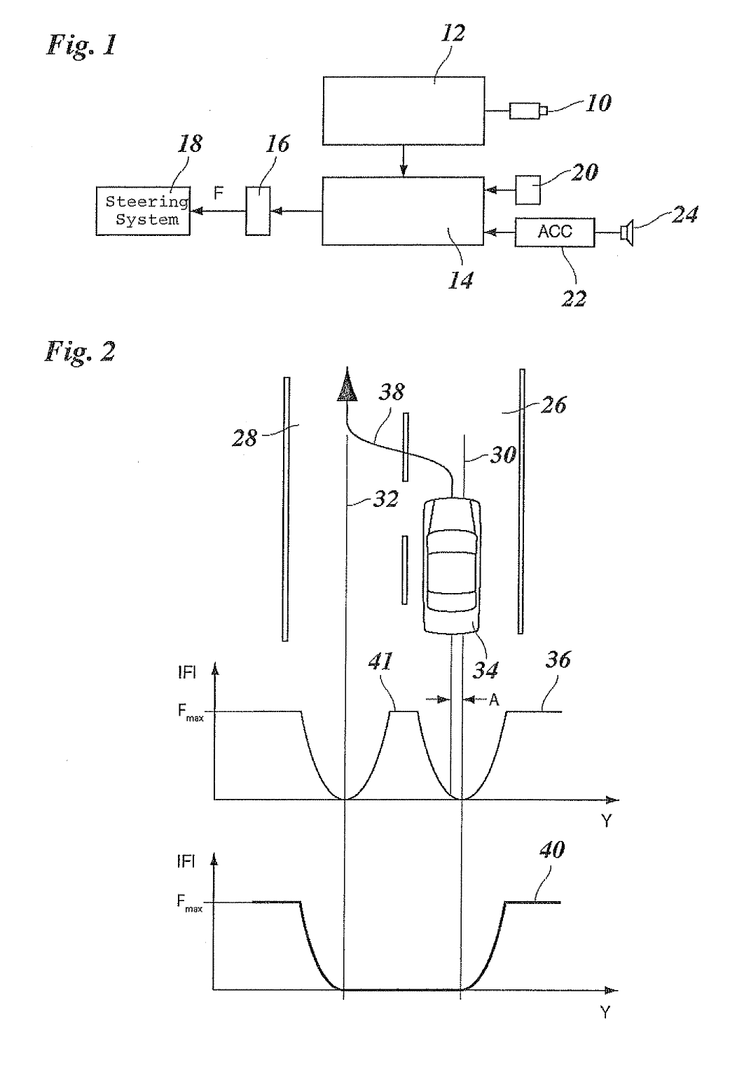

The lane maintenance assistant shown in FIG. 1 has, as a sensor device for recognizing the lanes of the roadway, a video camera 10 and an associated electronic evaluation system 12. A control device 14 determines, on the basis of the data from the sensor device, the course of the lane, the orientation of the vehicle in the lane, and the lateral position Y of the vehicle relative to the center of the home lane, and, as a function of these quantities, calculates a force that is applied to vehicle steering system 18 via an actuating element 16 in order to hold the vehicle approximately in the center of the lane or to guide it back to the center of the lane. Electronic evaluation system 12 and control device 14 can for example be formed by an electronic data processing system having one or more microprocessors and associated software. A sensor 20 acquires the state of the vehicle turn signal indicator, thus forming a device with which an intention to change lanes on the part of the driver, as well as the direction of the lane change, can be recognized.

In the depicted example, the vehicle is additionally equipped with an adaptive cruise control (ACC) system 22, which also includes a location system 24, for example a radar sensor, for locating vehicles in front of the home vehicle and for measuring the distances to and relative speeds of such vehicles. An intention to pass on the part of the driver can thus optionally also be determined on the basis of the traffic situation recognized by the ACC system. For example, a lane change intention is recognized only if the traffic situation suggests a change of lane in one direction or the other, and moreover the turn signal indicator for this direction is activated. Even if no ACC system is present, with the aid of video camera 10 it can be recognized on which lane the home vehicle is situated. If sensor 20 recognizes that for example the left blinker has been activated, this is interpreted as a lane change intention only if the vehicle is not already situated in the leftmost lane.

The functioning of control device 14 is now explained in more detail with reference to FIG. 2. In the upper part of this Figure, a roadway is shown having two lanes 26, 28. The target trajectories, running approximately in the center of the lane, are each marked by a line 30 or 32. A vehicle 34 that is equipped with the lane maintenance assistant as shown in FIG. 1 is traveling in right lane 26.

As long as no lane change intention on the part of the driver is recognized, the magnitude of the force F calculated by control device 14 and exerted on steering system 18 via actuating element 16 as a function of lateral position Y of vehicle 34 is indicated by curve 36 in FIG. 2. In practice, this force is a function of the deviation A of the vehicle from the target trajectory. The roadway curvature and vehicle orientation also contribute to this deviation; however, for the sake of simplicity this is not shown in FIG. 2. The part of curve 36 that corresponds to the right (home) lane 26 is symmetrical to a target trajectory 30 that is given for example by the center of the lane or by a particular target offset from the center of the lane. If the vehicle is traveling on the target trajectory, no steering intervention via actuating element 16 takes place, and if the lateral position of the vehicle in one direction or the other deviates from the target trajectory (deviation A), the force F exerted by actuating element 16 increases progressively up to a specified maximum value. The direction of the force is always such that the vehicle is led back to the target trajectory. The same holds correspondingly for the left part of curve 36, which corresponds to left lane 28 and which represents the lane maintenance function for travel on the left lane. The system operates in an analogous manner on roadways having three lanes.

In practice, curve 36 can be scaled as a function of the speed of vehicle 34, so that the magnitude of the steering intervention is a function of the vehicle speed in the particular situation.

An arrow 38 in the upper part of FIG. 2 represents a lane change of vehicle 34 from right lane 26 (home lane) to left lane 28, which is then the target lane.

If the driver's intention to carry out such a lane change is recognized, curve 36 is temporarily replaced by curve 40, shown in the lower part of FIG. 2. This curve is asymmetrical relative to the target trajectory on home lane 26, represented by line 30. If there are deviations to the left, in this case no steering intervention is carried out via actuating element 16, so that when steering towards the target lane the driver does not have to overcome a counterforce of actuating element 16. The branch of curve 40 to the right of the target trajectory is, in contrast, identical to the corresponding branch of curve 36, so that when there are deviations from the target trajectory to the right the lane maintenance function remains in effect.

In the depicted example, to the left of the target trajectory on target lane 28 represented by line 32, curve 40 again has an increasing branch that is identical to the corresponding branch of curve 36. As soon as, towards the end of the lane change process, vehicle 34 reaches the target trajectory in target lane 28, the lane maintenance function for deviations to the left therefore gradually comes back into effect, so that a possible overshooting past the target trajectory is reduced.

The reaching or crossing of line 32 (or the reaching of a y-position shortly before this line) can at the same time form a signal that the lane change process is complete. However, the lane change process may be regarded as completed if, after the blinker is activated, a prespecified time interval has elapsed. Upon completion of the lane change process, control device 14 returns to curve 36, so that now an automatic lane maintenance on the target trajectory of left lane 28 takes place. The transition from curve 40 to curve 36 can usefully take place in such a way that the right branch of curve 40 is gradually (continuously) displaced to the left, or the “mid-piece” 41 of the curve in FIG. 2 is gradually increased from 0 to Fₘₐₓ. In this way, the driver is kept from experiencing an abrupt change in force at the steering wheel when the symmetrical lane maintenance function resumes.

Alternatively, the right branch of curve 40 could also already gradually follow the movement of the vehicle during the lane change process. However, the variant described here, in which curve 40 is maintained in its shape until vehicle 34 has reached the target lane, has the advantage that the driver does not have to overcome any counterforce if traffic conditions force him to abort the lane change process.

The above-described manner of operation of control device 14 holds analogously for the case of a change from the left lane to the right lane.

1-5. (canceled)

6. A lane maintenance assistant for a motor vehicle, comprising:
a sensor device for recognizing lanes on a roadway;
a control device to exert a force on a steering system of the vehicle via an actuating element, so as to hold the vehicle in the lane; and
a recognition device to recognize an intention to change lanes on a part of a driver, wherein the control device is configured to asymmetrically modify the force exerted on the steering system when a lane change intention is recognized, so as to make easier the lane change.

7. The lane maintenance assistant of claim 6, wherein when an intention is recognized to change from a home lane to a target lane, a magnitude of the force exerted on the steering system is a function of a deviation of the vehicle from a target trajectory so that a force for lateral positions between a target trajectory on the home lane and a target trajectory on the target lane is reduced or is equal to zero, but increases again beyond the target trajectory of the target lane.

8. The lane maintenance assistant of claim 7, wherein a functional relation between the magnitude of the force and the deviation beyond the target trajectory of the target lane is identical to that for a lane maintenance function in the target lane without a lane change intention.

9. The lane maintenance assistant of claim 7, wherein the control device is configured so that the relation between the force and the deviation of the vehicle, which exists when a lane change intention is recognized, is maintained until the lane change has been completed.

10. The lane maintenance assistant of claim 7, wherein the control device is configured so that, upon completion of the lane change process, it effects a return to a regular, unmodified lane maintenance function through continuous modification of the relation indicating the functional relation of the force to the deviation.
